(19) United States
(12) Patent Application Publication
(10) Pub. No.: US 2024/0176174 A1
(43) Pub. Date: May 30, 2024

(54) FLEXIBLE DIMMING DEVICE AND ITS FABRICATION METHOD, GLASS ASSEMBLY, AUTOMOBILE, AND GLASS CURTAIN WALL

(71) Applicant: Shanghai Tianma Micro-electronics Co., Ltd., Shanghai (CN)

(72) Inventors: Zhen LIU, Shanghai (CN); Qingsan ZHU, Shanghai (CN); Xiaobing ZHAO, Shanghai (CN); Dongzhen ZHANG, Shanghai (CN); Fan XU, Shanghai (CN); Danping WANG, Shanghai (CN); Kerui XI, Shanghai (CN); Feng QIN, Shanghai (CN)

(21) Appl. No.: 18/126,004

(22) Filed: Mar. 24, 2023

(30) Foreign Application Priority Data
Nov. 30, 2022 (CN) 202211525906.6

(51) Int. Cl. G02F 1/1333; G02F 1/1335; G02F 1/1339; G02F 1/1347

(52) U.S. Cl. CPC G02F 1/133305; G02F 1/1335; G02F 1/1339; G02F 1/1347

(57) ABSTRACT

A flexible dimming device and its fabrication method, a glass assembly, an automobile, and a glass curtain wall. The flexible dimming device includes: a first flexible substrate and a second flexible substrate opposite to each other; a liquid crystal layer sandwiched between the first flexible substrate and the second flexible substrate where the liquid crystal layer includes guest-host liquid crystals and dye molecules; a first electrode and a second electrode; and an anti-ultraviolet film on a side of the first flexible substrate away from the second flexible substrate. The first electrode is located on a side of the first flexible substrate close to the liquid crystal layer and the second electrode is located on a side of the second flexible substrate close to the liquid crystal layer. The anti-ultraviolet film and the first flexible substrate are bonded by a first adhesive film.

### CROSS-REFERENCE TO RELATED APPLICATION

This application claims the priority of Chinese Patent Application No. 202211525906.6, filed on Nov. 30, 2022, the content of which is incorporated herein by reference in its entirety.

### TECHNICAL FIELD

The present disclosure generally relates to the field of dimming technology and, more particularly, relates to a flexible dimming device and its fabrication method, a glass assembly, an automobile, and a glass curtain wall.

### BACKGROUND

Dimming glass is a new type of special photoelectric glass product. Dimming glass has a sandwich structure, and is integrally formed by combining liquid crystal into the middle of two layers of glass and high temperature and high pressure adhesive. A user controls transparency and light-shielding states of the glass by controlling on and off states of the current. The glass itself not only has all characteristics of safety glass, but also has the privacy protection function by controlling whether the glass is transparent or not. It is used in high-speed rail, airplanes, vehicles, and other public transportation fields. In addition, because of the characteristics of the liquid crystal interlayer, dimming glass can also be used as a projection screen to replace ordinary curtain walls and present high-definition images on glass. Of course, to meet the needs of window glass or curtain bending, flexible dimming devices appear immediately.

In existing technologies, flexible substrate materials are generally used to replace rigid glass. First, flexible substrate materials are attached to the glass, and the glass is peeled off after forming a liquid crystal interlayer. However, there is a problem of residual adhesive after peeling off. In addition, the function of the dimming glass in the existing technologies is single. When it is applied in public transportation and other fields, other film layers need to be added, and the process is complicated.

Therefore, there is a need to provide a flexible dimming device capable of improving residual adhesive and superimposing other functions, its preparation method, glass assembly, automobiles and glass curtain walls.

### SUMMARY

One aspect of the present disclosure provides a flexible dimming device. The flexible dimming device includes: a first flexible substrate and a second flexible substrate opposite to each other; a liquid crystal layer sandwiched between the first flexible substrate and the second flexible substrate where the liquid crystal layer includes guest-host liquid crystals and dye molecules; a first electrode and a second electrode; and an anti-ultraviolet film on a side of the first flexible substrate away from the second flexible substrate. The first electrode is located on a side of the first flexible substrate close to the liquid crystal layer and the second electrode is located on a side of the second flexible substrate close to the liquid crystal layer. The anti-ultraviolet film and the first flexible substrate are bonded by a first adhesive film.

Another aspect of the present disclosure provides a glass assembly. The glass assembly includes a flexible dimming device. The flexible dimming device includes: a first flexible substrate and a second flexible substrate opposite to each other; a liquid crystal layer sandwiched between the first flexible substrate and the second flexible substrate where the liquid crystal layer includes guest-host liquid crystals and dye molecules; a first electrode and a second electrode; and an anti-ultraviolet film on a side of the first flexible substrate away from the second flexible substrate. The first electrode is located on a side of the first flexible substrate close to the liquid crystal layer and the second electrode is located on a side of the second flexible substrate close to the liquid crystal layer. The anti-ultraviolet film and the first flexible substrate are bonded by a first adhesive film. The glass assembly further includes a first glass on a side of the anti-ultraviolet film away from the first flexible substrate; and a second glass on a side of the second flexible substrate away from the first flexible substrate. The first glass and the anti-ultraviolet film are bonded through a fourth adhesive film; and the second glass and the anti-ultraviolet film are bonded through a fifth adhesive film.

Another aspect of the present disclosure provides an automobile. The automobile includes a glass assembly. The glass assembly includes a flexible dimming device. The flexible dimming device includes: a first flexible substrate and a second flexible substrate opposite to each other; a liquid crystal layer sandwiched between the first flexible substrate and the second flexible substrate where the liquid crystal layer includes guest-host liquid crystals and dye molecules; a first electrode and a second electrode; and an anti-ultraviolet film on a side of the first flexible substrate away from the second flexible substrate. The first electrode is located on a side of the first flexible substrate close to the liquid crystal layer and the second electrode is located on a side of the second flexible substrate close to the liquid crystal layer. The anti-ultraviolet film and the first flexible substrate are bonded by a first adhesive film. The glass assembly further includes a first glass on a side of the anti-ultraviolet film away from the first flexible substrate; and a second glass on a side of the second flexible substrate away from the first flexible substrate. The first glass and the anti-ultraviolet film are bonded through a fourth adhesive film; and the second glass and the anti-ultraviolet film are bonded through a fifth adhesive film.

Another aspect of the present disclosure provides a glass curtain wall. The glass curtain wall includes a glass assembly. The glass assembly includes a flexible dimming device. The flexible dimming device includes: a first flexible substrate and a second flexible substrate opposite to each other; a liquid crystal layer sandwiched between the first flexible substrate and the second flexible substrate where the liquid crystal layer includes guest-host liquid crystals and dye molecules; a first electrode and a second electrode; and an anti-ultraviolet film on a side of the first flexible substrate away from the second flexible substrate. The first electrode is located on a side of the first flexible substrate close to the liquid crystal layer and the second electrode is located on a side of the second flexible substrate close to the liquid crystal layer. The anti-ultraviolet film and the first flexible substrate are bonded by a first adhesive film. The glass assembly further includes a first glass on a side of the anti-ultraviolet film away from the first flexible substrate; and a second glass on a side of the second flexible substrate away from the first flexible substrate. The first glass and the anti-ultraviolet film are bonded through a fourth adhesive film; and the second glass and the anti-ultraviolet film are bonded through a fifth adhesive film.

Another aspect of the present disclosure provides a fabrication method of a flexible dimming device. The method includes: forming a first composite substrate, and forming a second composite substrate. Forming the first composite substrate includes: providing a first glass substrate, forming a sixth adhesive film on a side of the first glass substrate, coating an anti-ultraviolet film on a side of the sixth adhesive film away from the first glass substrate, forming a first adhesive film on a side of the anti-ultraviolet film away from the first glass substrate, bonding a first flexible substrate on a side of the first adhesive film away from the first glass substrate, and forming a first electrode on the side of the first flexible substrate away from the first glass substrate, wherein the sixth adhesive film includes ultraviolet dissociation adhesive. Forming the second composite substrate includes: providing a second glass substrate, forming a seventh adhesive film on a side of the second glass substrate, bonding a second flexible base on a side of the seventh adhesive film away from the second glass substrate, and forming a second electrode on the side of the second flexible substrate away from the second glass substrate, wherein the seventh adhesive film includes ultraviolet dissociation adhesive. The method further includes: coating a side of the first electrode in the first composite substrate with a sealant material wherein the sealant material surrounds and defines a first region of guest-host liquid crystals and dye molecules, dripping the guest-host liquid crystal and the dye molecules into the first region, and bonding the second composite substrate such that the second electrode is located on a side of the second flexible substrate close to the first composite substrate; or, coating a side of the first electrode in the first composite substrate with a sealant material wherein the sealant material surrounds and defines a first region of guest-host liquid crystals and dye molecules and a channel for guest-host liquid crystals and dye molecules is preserved, bonding the first composite substrate and the second composite substrate, and injecting the guest-host liquid crystals and dye molecules through the channel. Then the sealant material is irradiated with ultraviolet rays on the side of the second glass substrate away from the first glass substrate to cure the sealant material to form a sealant. The method further includes: irradiating the first composite substrate with ultraviolet rays on the side of the first composite substrate away from the second composite substrate, to dissociate the sixth adhesive film and peel off the first glass substrate, and then irradiating the second composite substrate with ultraviolet rays on the side of the second composite substrate away from the first composite substrate to dissociate the seventh adhesive film and peel off the second glass substrate to obtain the flexible dimming device; or, irradiating the second composite substrate with ultraviolet rays on the side of the second composite substrate away from the first composite substrate, to dissociate the seventh adhesive film and peel off the second glass substrate, and then irradiating the first composite substrate with ultraviolet rays on the side of the first composite substrate away from the second composite substrate to dissociate the sixth adhesive film and peel off the first glass substrate to obtain the flexible dimming device.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a flexible dimming device consistent with various disclosed embodiments of the present disclosure;

FIG. 2 illustrates another flexible dimming device consistent with various disclosed embodiments of the present disclosure;

FIG. 3 illustrates another flexible dimming device consistent with various disclosed embodiments of the present disclosure;

FIG. 4 illustrates another flexible dimming device consistent with various disclosed embodiments of the present disclosure;

FIG. 5 illustrates another flexible dimming device consistent with various disclosed embodiments of the present disclosure;

FIG. 6 illustrates another flexible dimming device consistent with various disclosed embodiments of the present disclosure;

FIG. 7 illustrates an exemplary glass assembly consistent with various disclosed embodiments of the present disclosure;

FIG. 8 illustrates another exemplary glass assembly consistent with various disclosed embodiments of the present disclosure;

FIG. 9 illustrates another exemplary glass assembly consistent with various disclosed embodiments of the present disclosure;

FIG. 10 illustrates an exemplary automobile consistent with various disclosed embodiments of the present disclosure;

FIG. 11 illustrates another exemplary glass assembly consistent with various disclosed embodiments of the present disclosure;

FIG. 12 illustrates an exemplary glass curtain wall consistent with various disclosed embodiments of the present disclosure;

FIG. 13 illustrates an exemplary preparation method of a flexible dimming device consistent with various disclosed embodiments of the present disclosure;

FIG. 14 illustrates structures corresponding to various steps of a method for forming a first composite substrate consistent with various disclosed embodiments of the present disclosure;

FIG. 15 illustrates structures corresponding to various steps of a method for forming a second composite substrate consistent with various disclosed embodiments of the present disclosure;

FIG. 16 illustrates an exemplary liquid crystal cell consistent with various disclosed embodiments of the present disclosure;

FIG. 17 illustrates another exemplary preparation method of a flexible dimming device consistent with various disclosed embodiments of the present disclosure;

FIG. 18 illustrates another method for forming a second composite substrate consistent with various disclosed embodiments of the present disclosure;

FIG. 19 illustrates another exemplary preparation method of a flexible dimming device consistent with various disclosed embodiments of the present disclosure;

FIG. 20 illustrates another method for forming a first composite substrate consistent with various disclosed embodiments of the present disclosure;

FIG. 21 illustrates an exemplary method for forming sealant consistent with various disclosed embodiments of the present disclosure; and

FIG. 22 illustrates an exemplary planar structure of a mask consistent with various disclosed embodiments of the present disclosure.

### DETAILED DESCRIPTION

Reference will now be made in detail to exemplary embodiments of the disclosure, which are illustrated in the accompanying drawings. Hereinafter, embodiments consistent with the disclosure will be described with reference to drawings. In the drawings, the shape and size may be exaggerated, distorted, or simplified for clarity. Wherever possible, the same reference numbers will be used throughout the drawings to refer to the same or like parts, and a detailed description thereof may be omitted.

Further, in the present disclosure, the disclosed embodiments and the features of the disclosed embodiments may be combined under conditions without conflicts. It is apparent that the described embodiments are some but not all of the embodiments of the present disclosure. Based on the disclosed embodiments, persons of ordinary skill in the art may derive other embodiments consistent with the present disclosure, all of which are within the scope of the present disclosure.

Moreover, the present disclosure is described with reference to schematic diagrams. For the convenience of descriptions of the embodiments, the cross-sectional views illustrating the device structures may not follow the common proportion and may be partially exaggerated. Besides, those schematic diagrams are merely examples, and not intended to limit the scope of the disclosure. Furthermore, a three-dimensional (3D) size including length, width, and depth should be considered during practical fabrication.

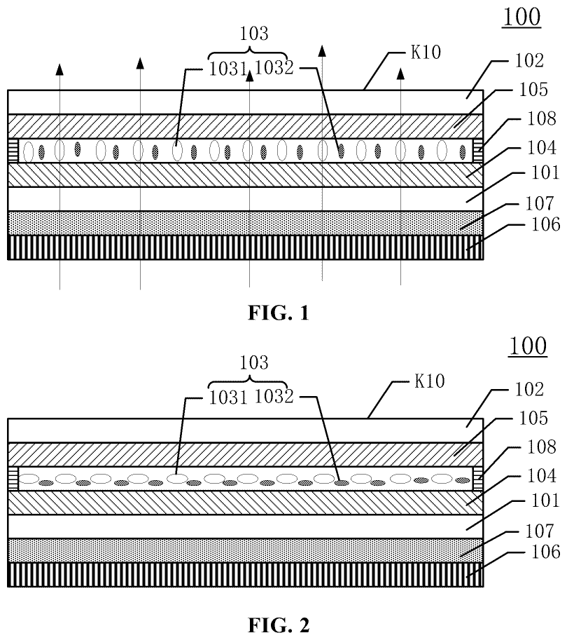

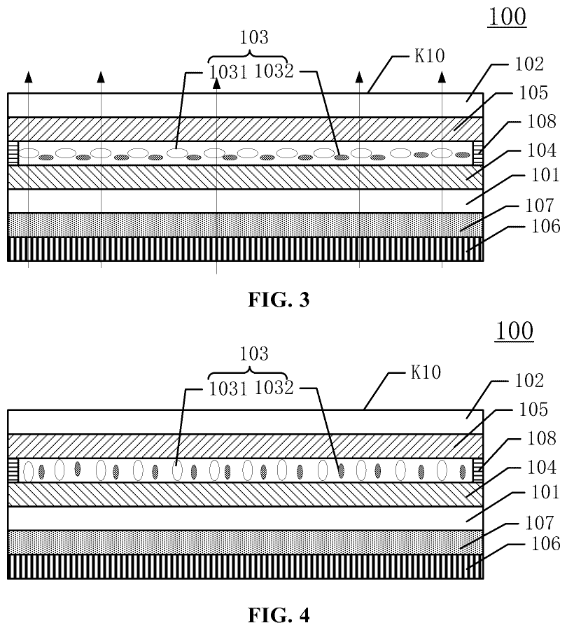

The present disclosure provides a flexible dimming device. FIG. 1 illustrates an exemplary flexible dimming device provided by one embodiment of the present disclosure. FIG. 2 illustrates another exemplary flexible dimming device provided by one embodiment of the present disclosure. Guest-host liquid crystals in FIG. 1 and FIG. 2 may be all negative liquid crystals. The flexible dimming device in FIG. 1 may be in a transparent state, and the flexible dimming device in FIG. 2 may be in a light-shielding state. FIG. 3 illustrates another exemplary flexible dimming device provided by one embodiment of the present disclosure. FIG. 4 illustrates an exemplary flexible dimming device provided by one embodiment of the present disclosure. Guest-host liquid crystals in FIG. 3 and FIG. 4 may be all negative liquid crystals. The flexible dimming device in FIG. 3 may be in the transparent state, and the flexible dimming device in FIG. 4 may be in the light-shielding state. As shown in FIG. 1 to FIG. 4, in one embodiment, the flexible dimming device 100 may include a first flexible substrate 101 and a second flexible substrate 102 oppositely arranged with respect to each other, and a liquid crystal layer 103 sandwiched between the first flexible substrate 101 and the second flexible substrate 102. The liquid crystal layer 103 may include guest-host liquid crystals 1031 and dye molecules 1032. The flexible dimming device 100 may further include a first electrode 104 and a second electrode 105. The first electrode 104 may be located on a side of the first flexible substrate 101 close to the liquid crystal layer 103, and the second electrode 105 may be located on a side of the second flexible substrate 102 close to the liquid crystal layer 103. A side of the first flexible substrate 101 away from the second flexible substrate 102 may be further provided with an anti-ultraviolet film 106. The anti-ultraviolet film 106 may be bonded to the first flexible substrate 101 through a first adhesive film 107.

The flexible substrates in the present disclosure may be made of a material that can be bent relative to a rigid material, and the material of the flexible substrates is not specifically limited here. In FIG. 1 to FIG. 4, pattern filling is not performed on the first flexible substrate 101 and the second flexible substrate 102. A sealant 108 is also shown in FIG. 1 to FIG. 4.

Optionally, the flexible dimming device 100 may have two states: a transparent state (refer to FIG. 1 and FIG. 3) and a light-shielding state (refer to FIGS. 2 and 4). The liquid crystal layer 103 may include the guest-host liquid crystal molecules 1031 and the dye molecules 1032. The first electrode 104 may be disposed on the side of the first flexible substrate 101 away from the first adhesive film 107, and the second electrode 105 may be disposed on the side of the second flexible substrate 102 close to the liquid crystal layer 103. Electric field between the first electrode 104 and the second electrode 105 may be used to control the deflection of the guest-host liquid crystals 1031. Of course, since the flexible dimming device 100 only needs to switch between the transparent and light-shielding states, and does not need to control the liquid crystal partitions, the first electrode 104 and the second electrode 105 may be full-surface electrodes. Optionally, the first electrode 104 and the second electrode 105 may be made of indium tin oxide (ITO) which has good conductivity and transparency to cut off harmful electron radiation, ultraviolet rays and far infrared rays. Using ITO in the flexible dimming device 100 of the present disclosure as a transparent conductive film, harmful electron radiation, ultraviolet rays, infrared rays, etc., which are harmful to the human body, may be reduced simultaneously. The first electrode 104 and the second electrode 105 may be formed by a sputtering method.

Liquid crystal molecules have dielectric and refractive index anisotropy, and the alignment direction of liquid crystal molecules may be changed by the action of an electric field. Although the dye molecules 1032 have no dielectric anisotropy (that is, the dye molecules 1032 are not controlled by an electric field), the dye molecules 1032 are soluble in main bodies of the guest-host liquid crystal molecules 1031 which are aligned. Therefore, the dye molecules 1032 may be arranged in the same direction as the liquid crystal molecules, that is, the rotation direction of the dye molecules 1032 may be the same as that of the liquid crystal molecules.

Optionally, in one embodiment, the guest-host liquid crystals 1031 may be positive liquid crystals (as shown in FIG. 3 and FIG. 4) or negative liquid crystals (as shown in FIG. 1 and FIG. 2). The dielectric constant in a long axis direction of a positive liquid crystal molecule may be larger than the dielectric constant in the short axis direction. Therefore, when it is controlled by an electric field, the long axis direction of the positive liquid crystal molecule may be deflected along the direction parallel to the electric field. The dielectric constant in the long axis direction of a negative liquid crystal molecule is less than the dielectric constant in the short axis direction. Therefore, when it is controlled by an electric field, the long axis direction of the negative liquid crystal molecule may be deflected along the direction perpendicular to the electric field. In this embodiment, the embodiment shown in FIG. 1 and FIG. 2 where the guest-host liquid crystals 1031 are negative liquid crystals, and the embodiment shown in FIG. 3 and FIG. 4 where the guest-host liquid crystals 1031 are positive liquid crystals, are used as examples to illustrate the present disclosure.

In one embodiment, the guest-host liquid crystals 1031 are negative liquid crystals. As shown in FIG. 1, when the first electrode 104 and the second electrode 105 are not powered, the long axis of the negative liquid crystals may be perpendicular to a light-emitting surface K10 of the flexible dimming device 100, and the light may be able to be emitted along the direction of the long axis of the liquid crystals. Correspondingly, the flexible dimming device 100 may be in the transparent state. As shown in FIG. 2, when the first electrode 104 and the second electrode 105 are powered, the long axis direction of the negative liquid crystals may be deflected along the direction perpendicular to the electric field, such that the long axis of the guest-host liquid crystals 1031 may be parallel to the light-emitting surface K10 of the flexible dimming device 100. Light may not be able to be emitted from the flexible dimming device 100, and the flexible dimming device 100 may be in the light-shielding state. At this time, the flexible dimming device 100 may have a light-shielding effect. Of course, the liquid crystal alignment here may be a vertical alignment.

In some other embodiments, the guest-host liquid crystals 1031 are positive liquid crystals. As shown in FIG. 3, when the first electrode 104 and the second electrode 105 are not powered, the long axis of the positive liquid crystals may be parallel to the light-emitting surface K10 of the flexible dimming device 100, and the light may be able to be emitted along the direction of the long axis of the liquid crystals. Correspondingly, the flexible dimming device 100 may be in the transparent state. As shown in FIG. 4, when the first electrode 104 and the second electrode 105 are powered, the long axis direction of the positive liquid crystals may be deflected along the direction parallel to the electric field, such that the long axis of the guest-host liquid crystals 1031 may be perpendicular to the light-emitting surface K10 of the flexible dimming device 100. Light may not be able to be emitted from the flexible dimming device 100, and the flexible dimming device 100 may be in the light-shielding state. At this time, the flexible dimming device 100 may have a light-shielding effect. Of course, the liquid crystal alignment here may be an antiparallel alignment.

The flexible dimming device 100 provided by the present disclosure may be able to realize the dimming function, that is, switching between the transparent and light-shielding states. Light may be able to pass through the flexible dimming device 100 in the transparent state, and may not be able to pass through the flexible dimming device 100 in the light-shielding state 100 to achieve the light-shielding effect. Since the first flexible substrate 101 and the second flexible substrate 102 may be made of flexible materials, the requirement of bending may be met.

In one embodiment, the side of the first flexible base 101 away from the second flexible base 102 may be further provided with the anti-ultraviolet film 106. The anti-ultraviolet film 106 may have the function of preventing ultraviolet rays from passing through, and the transmittance of the ultraviolet rays irradiating on the anti-ultraviolet film 106 may be very low. Therefore, the flexible dimming device 100 may have the function of ultraviolet protection while having the function of dimming. Materials of the anti-ultraviolet film 106 is not specifically limited here, and any material that is able to reduce the transmittance of ultraviolet rays may be applicable. It should be understood that the flexible dimming device 100 is usually used on the glass of the rail transit industry to meet the bending requirements, and the rail transit glass usually requires anti-ultraviolet function. Correspondingly, after the flexible dimming device 100 is clamped on the glass, an anti-ultraviolet film layer is needed to be provided on the outside of the glass, which increases the production process and the production cost virtually. In the present disclosure, the anti-ultraviolet film 106 may be directly integrated into the flexible dimming device 100, and there may be no need to attach an anti-ultraviolet film layer on the outside of the glass, which reduces the production process and production cost.

The anti-ultraviolet film 106 and the first flexible substrate 101 may be attached by the first adhesive film 107, where the first adhesive film 107 may play the role of fixing the anti-ultraviolet film 106 and the first flexible substrate 101. Therefore, the first adhesive film 107 may be required to have a higher viscosity to avoid detachment of the anti-ultraviolet film 106 and the first flexible substrate 101 under long-term light conditions. Of course, to achieve the light transmittance of the flexible dimming device 100 in the transparent state, the first adhesive film 107 may be made of materials with high light transmittance such as optical adhesive, to avoid reducing of the light transmittance of the flexible dimming device 100 in the transparent state.

In the present disclosure, the flexible dimming device 100 may be able to realize the dimming function, that is, switching between the transparent and light-shielding states. Light may be able to pass through the flexible dimming device 100 in the transparent state, and may not be able to pass through the flexible dimming device 100 in the light-shielding state 100 to achieve the light-shielding effect. Since the first flexible substrate 101 and the second flexible substrate 102 may be made of flexible materials, the requirement of bending may be met.

Further, the side of the first flexible base 101 away from the second flexible base 102 may be further provided with the anti-ultraviolet film 106. The anti-ultraviolet film 106 may have the function of preventing ultraviolet rays from passing through, and the transmittance of the ultraviolet rays irradiating on the anti-ultraviolet film 106 may be very low. Therefore, the flexible dimming device 100 may have the function of ultraviolet protection while having the function of dimming. The anti-ultraviolet film 106 may be directly integrated into the flexible dimming device 100, and there may be no need to attach an anti-ultraviolet film layer on the outside of the glass, which reduces the production process and production cost.

In some embodiments, as shown in FIG. 1, FIG. 2, FIG. 3 and FIG. 4, the first adhesive film 107 may include one of pressure sensitive adhesive, optical adhesive or liquid optical adhesive.

The anti-ultraviolet film 106 and the first flexible substrate 101 may be attached by the first adhesive film 107, where the first adhesive film 107 plays a role of fixing the anti-ultraviolet film 106 and the first flexible substrate 101. Therefore, the first adhesive film 107 may be required to have a higher viscosity.

The pressure-sensitive adhesive has long-lasting high viscosity. It only needs to apply pressure to bond the upper and lower layers of adherents. It does not need to be activated by water, solvents or heat. Because of its strong cohesive force, it may be able to play the role of attaching the anti-ultraviolet film 106 and the first flexible substrate 101.

The optical adhesive (OCA) is a special adhesive used for bonding transparent optical components. Since optical adhesive has the characteristics of being colorless, transparent with a light transmittance above 90%, and good bonding strength, when the anti-ultraviolet film 106 and the first flexible substrate 101 are fixed by the optical adhesive, the optical adhesive may not only play a relatively good bonding effect, but also ensure the light transmittance of the flexible dimming device 100 in the light-transmitting state.

The liquid optical adhesive (LOCA) is a special adhesive used for bonding transparent optical components. Since it has the characteristics of colorless transparency with a light transmittance above 98%, and good bonding strength, when the anti-ultraviolet film 106 and the first flexible substrate 101 are fixed by the liquid optical adhesive, the optical adhesive may not only play a relatively good bonding effect, but also ensure the light transmittance of the flexible dimming device 100 in the light-transmitting state. Further, the liquid optical adhesive also has the characteristics of a small curing shrinkage rate. After curing, there may be no change on the surface of the anti-ultraviolet film 106 and the first flexible substrate 101. Moreover, the liquid optical adhesive can resist yellowing. Even after the flexible dimming device 100 is exposed to ambient light for a long time, the liquid optical adhesive may be still able to play the role of resisting yellowing.

In some optional embodiments, as shown in FIG. 1, FIG. 2, FIG. 3 and FIG. 4, the anti-ultraviolet film 106 may include an anti-ultraviolet coating.

Specifically, the first adhesive film 107 may be pasted on the side of the first flexible substrate 101 far away from the second flexible substrate 102, and then the anti-ultraviolet coating may be formed by solution spin coating or scraping coating. After curing, the anti-ultraviolet layer 106 may be formed.

Of course, the function of the anti-ultraviolet film 106 may be to prevent ultraviolet rays from passing through. In some other embodiments, anti-ultraviolet materials may be formed into a film and directly attached to the side of the first flexible substrate 101 away from the second flexible substrate 102 through the first adhesive film 107.

In some other embodiments, the ultraviolet absorbing material may be doped into a base material of the first flexible substrate 101 or an adhesive of the first adhesive film 107, such that the first flexible substrate 101 or the first adhesive film 107 has an anti-ultraviolet function. When the ultraviolet absorbing material is doped into the first flexible substrate 101, the first flexible substrate 101 may be able to have the function of preventing ultraviolet rays without adding the first adhesive film 107 or the anti-ultraviolet film. Also, the number of film layers and the overall thickness of the flexible dimming device 100 may be reduced, to reduce the complexity and cost of the manufacturing process.

In some optional embodiments, as shown in FIG. 1, FIG. 2, FIG. 3 and FIG. 4, the anti-ultraviolet film 106 may be made of a material including polyethylene naphthalate or an ultraviolet blocking agent.

Polyethylene naphthalate (PEN) is one of the important members of the polyester family, which is formed by polycondensation of 2,6-dimethyl naphthalate (NDC) or 2,6-naphthalene dicarboxylic acid (NDA) with ethylene. PEN is a new excellent polymer with a more rigid naphthalene ring in the molecular chain. The naphthalene ring structure may make polyethylene naphthalate have higher physical and mechanical properties, gas barrier properties, chemical stability, heat resistance, ultraviolet resistance, radiation resistance and other properties. Because the bicyclic structure of naphthalene has a strong ability to absorb ultraviolet light, polyethylene naphthalate may be able to block ultraviolet rays less than 380 nm, and its blocking effect may be significant.

Doping a certain amount of an ultraviolet blocking agent in polyethylene naphthalate may be able to make it better play the role of anti-ultraviolet rays. For example, the ultraviolet blocking agent may be one or more of nano-zinc oxide, nano-titanium dioxide, or nano-silicon dioxide. Of course, some other substances may be used, as long as they have the effect of blocking ultraviolet rays. In terms of particle size, when the particle size of the ultraviolet blocking agent is smaller, the capability to block ultraviolet rays may be higher. The ultraviolet rays may be scattered on the surface of the ultraviolet blocking agent, such that the ultraviolet rays are unable to pass through the anti-ultraviolet film 106, to achieve the purpose of preventing ultraviolet rays from passing through.

Polyethylene naphthalate may cooperate with the ultraviolet blocking agent. The double ring structure of polyethylene naphthalate may make it have a strong ability to absorb ultraviolet light, while the ultraviolet blocking agent may make the ultraviolet rays scattered on its surface. Therefore, the ultraviolet rays may be well prevented from passing through the ultraviolet protection film 106.

The first flexible substrate 101 and the second flexible substrate 102 may be made of a material including one or more of polyimide, polyethylene naphthalate, cellulose triacetate, or cycloolefin polymer.

Optionally, polyimide (PI) is one of the organic polymer materials with the best comprehensive performance. Its high temperature resistance is above 400° C., and its long-term use temperature range is −200° ° C.˜300° ° C. It also has excellent mechanical properties and high radiation resistance. The use of polyimide in the first flexible substrate 101 and the second flexible substrate 102 may be beneficial to ensure the mechanical properties of the flexible dimming device 100. Since its long-term service temperature range is between −200° ° C. and 300° C., the service life of the flexible dimming device 100 may be guaranteed, and the use environment of the flexible dimming device 100 may be wider. Further, polyimide has excellent Physical properties and thickness is able to be made thinner. The first flexible substrate 101 and the second flexible substrate 102 made of polyimide may have good physical properties and may not increase the overall thickness of the flexible dimming device 100.

Optionally, there are more rigid naphthalene rings in the molecular chain of polyethylene naphthalate, and the naphthalene ring structure makes polyethylene naphthalate have higher physical and mechanical properties, gas barrier performance, chemical stability, heat resistance, ultraviolet resistance, radiation resistance and other properties. The first flexible substrate 101 and the second flexible substrate 102 made of polyethylene naphthalate may ensure the mechanical properties of the flexible dimming device 100. And to a certain extent, it may also have the effect of heat resistance and ultraviolet protection. Further, polyethylene naphthalate has excellent physical properties and can be made thinner. The first flexible substrate 101 and the second flexible substrate 102 made of polyethylene naphthalate may have good physical properties without increasing the overall thickness of the flexible dimming device 100.

Cellulose triacetate (TCA) is a material with high mechanical strength, strong penetration resistance, good internal resistance, good chemical stability, and good transparency. On the one hand, because of the high mechanical strength of TCA, by using TCA in the first flexible substrate 101 and the second flexible substrate 102, the mechanical properties of the flexible dimming device 100 may be guaranteed, and its transparency may be good, which may improve the transmittance of the flexible dimming device 100 in the transparent state.

Cyclo olefin polymer has the advantages of high transparency, low birefringence, low water absorption, high rigidity, high heat resistance, and good water vapor airtightness. On the one hand, because of the high rigidity, by using cyclo olefin polymer in the first flexible substrate 101 and the second flexible substrate 102, the mechanical properties of the flexible dimming device 100 may be guaranteed, and its high transparency may improve the light transmittance of the flexible dimming device 100 in the transparent state.

In various embodiments, the first flexible substrate 101 or the second flexible substrate 102 may only include one of polyimide, polyethylene naphthalate, cellulose triacetate, or cycloolefin polymer, or may include a mixture of two or more of polyimide, polyethylene naphthalate, cellulose triacetate, or cycloolefin polymers. When the first flexible substrate 101 or the second flexible substrate 102 include the above-mentioned mixture of two or more of polyimide, polyethylene naphthalate, cellulose triacetate, or cycloolefin polymer, the advantages of any one of these materials may be achieved.

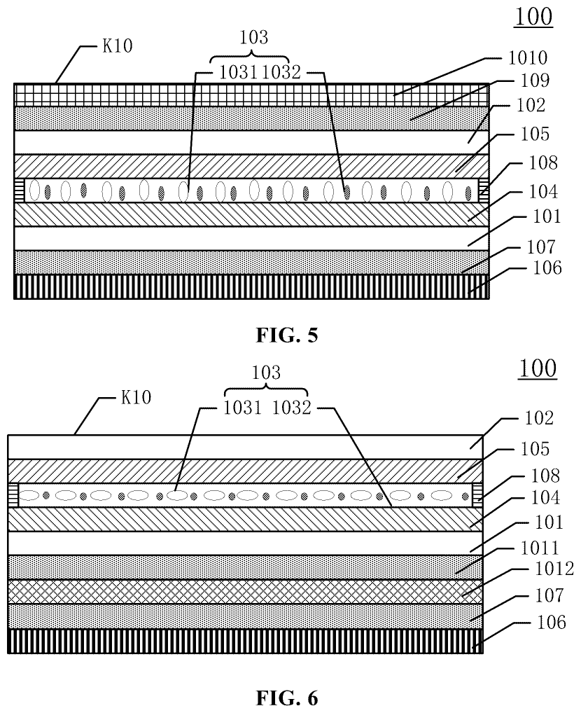

In some other embodiments, as shown in FIG. 5 which illustrates another exemplary structure of the flexible dimming device 100, the flexible dimming device 100 may further include a first anti-infrared film 1010 on a side of the second flexible substrate 102 away from the first flexible substrate 101. The first anti-infrared film 1010 may be bonded to the second flexible substrate 102 through a second adhesive film 109.

As shown in FIG. 5, in the flexible dimming device 100, the first anti-infrared film 1010 may be attached on the side of the second flexible substrate 102 away from the first flexible substrate through the second adhesive film 109. The first anti-infrared film 1010 may block the incidence of infrared rays, such that the flexible dimming device 100 may have an additional heat insulation function. The position of the first anti-infrared film 1010 is not specifically limited. The embodiment where the first anti-infrared film 1010 is located on the side of the second flexible base 102 away from the first flexible substrate is used as an example for illustration. The first anti-infrared film 1010 may be made of materials in the related technology such as inorganic oxides. The material of the first anti-infrared film 1010 is not specifically limited here, and the periodic stacked structure of silicon dioxide and titanium dioxide may be used optionally. Of course, for silicon dioxide or titanium dioxide, the barrier effect may be better when the particle size is smaller.

There are about 53% of infrared rays in sunlight, and infrared rays are the main source of heat felt by sunlight and the invisible heat in sunlight. The first anti-infrared film 1010 may play a role of blocking infrared rays. The higher the blocking rate of the first anti-infrared film 1010 is, the stronger the ability to block infrared rays may be. In the present disclosure, the first anti-infrared film 1010 may be added on one side of the flexible substrate to block infrared rays, such that the flexible dimming device 100 may have an additional heat insulation function.

In some other embodiments, as shown in FIG. 6 which illustrates another exemplary structure of the flexible dimming device 100, the flexible dimming device 100 may further include a second anti-infrared film 1012 on a side of the first adhesive film 107 away from the anti-ultraviolet film 106. The second anti-infrared film 1012 may be bonded with the first flexible substrate 101 through a third adhesive film 1011.

As shown in FIG. 6, in the flexible dimming device 100, the second anti-infrared film 1012 may be attached on the side of the first adhesive film 107 away from the anti-ultraviolet film 106 through the third adhesive film 1011. That is, the side of the first flexible base 101 away from the second flexible base 102 may be provided with the third adhesive film 1011, and the side of the third adhesive film 1011 away from the second flexible base 102 may be provided with the second anti-infrared film 1012. The side of the second anti-infrared film 1012 away from the second flexible base 102 may be provided with the first adhesive film 107, and the side of the first adhesive film 107 away from the second flexible substrate 102 may be provided with the anti-ultraviolet film 106. The second anti-infrared film 1012 may block the incidence of infrared rays, such that the flexible dimming device 100 may have an additional heat insulation function. The position of the second anti-infrared film 1012 is not specifically limited here. The embodiment where the second anti-infrared film 1012 is located between the first flexible substrate 101 away from the anti-ultraviolet film 106 is used as an example for illustration. The second anti-infrared film 1012 may be made of materials in the related technology such as inorganic oxides. The material of the first anti-infrared film 1010 is not specifically limited here.

There are about 53% of infrared rays in sunlight, and infrared rays are the main source of heat felt by sunlight and the invisible heat in sunlight. The second anti-infrared film 1012 may play a role of blocking infrared rays. The higher the blocking rate of the second anti-infrared film 1012 is, the stronger the ability to block infrared rays may be. In the present disclosure, the second anti-infrared film 1012 may be added on one side of the anti-ultraviolet film 106 closed to the first flexible substrate 101 to block infrared rays, such that the flexible dimming device 100 may have an additional heat insulation function.

The anti-infrared films may be disposed on one side of the first flexible substrate 101 and one side of the second flexible substrate at the same time. In some other embodiment, to reduce the number of film layers on the flexible dimming device to prevent curling, the anti-infrared films may be arranged only on one side of the first flexible substrate 101 or only on one side of the second flexible substrate 102.

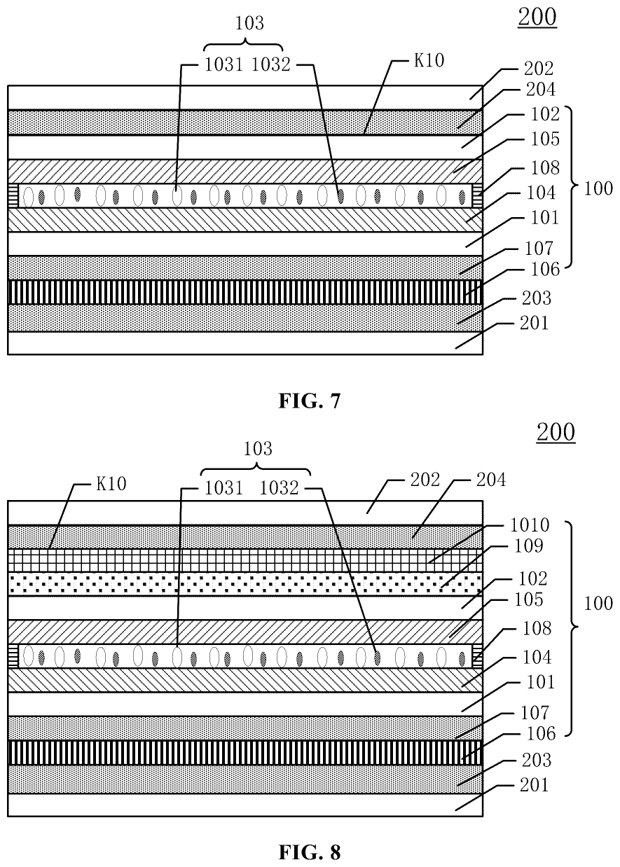

The present disclosure also provides a glass assembly 200. As shown in FIG. 7, which is a schematic structure of the glass assembly, the glass assembly 200 may include a flexible dimming device 100 provided by any embodiments of the present disclosure. The glass assembly 200 in FIG. 7 may further include a first glass 201 on a side of the anti-ultraviolet film 106 away from the first flexible substrate 101, and a second glass substrate 503 on the side of the second flexible substrate 102 away from the first flexible substrate 101. The first glass 201 and the anti-ultraviolet film 106 may be bonded through a fourth adhesive film 203, and the second glass substrate 503 and the second flexible substrate 102 may be bonded through a fifth adhesive film 204.

Specifically, the first glass 201 and the second glass substrate 503 may be made of tempered glass. The tempered glass has high hardness and can prevent scratches. Optionally, chemical or physical methods may be used to form compressive stress on the surfaces of the first glass 201 and the second glass substrate 503. Therefore, when the glass is subjected to external force, the surface stress may be first offset, thereby improving the bearing capacity of the first glass 201 and the second glass substrate 503. The strength of the wind pressure resistance and impact resistance of the glass assembly 200 itself may be improved.

In FIG. 7, pattern filling may not be performed on the first glass 201 and the second glass substrate 503.

The flexible dimming device 100 in FIG. 7 may include the first flexible substrate 101 and the second flexible substrate 102 disposed opposite to each other, and the liquid crystal layer 103 sandwiched between the first flexible substrate 101 and the second flexible substrate 102. The liquid crystal layer 103 may include guest-host liquid crystal 1031 and dye molecules 1032. The flexible dimming device 100 may further include the first electrode 104 and the second electrode 105. The first electrode 104 may be located on the side of the first flexible substrate 101 away from the first adhesive film 107, and the second electrode 105 may be located on the side of the second flexible substrate 102 close to the liquid crystal layer 103. The anti-ultraviolet film 106 may be disposed on the side of the first flexible substrate 101 away from the second flexible substrate 102. The anti-ultraviolet film 106 and the first flexible substrate 101 may be bonded through the first adhesive film 107. In this embodiment, the flexible dimming device 100 may be sandwiched between the first glass 201 and the second glass substrate 503. The first glass 201 and the anti-ultraviolet film 106 may be bonded through the fourth adhesive film 203. The second glass substrate 503 and the second flexible substrate 102 may be bonded together through the fifth adhesive film 204. The fourth adhesive film 203 and the fifth adhesive film 204 may be respectively used for bonding and fixing the flexible dimming device 100 and the first glass 201, and bonding and fixing the flexible dimming device 100 and the second glass substrate 503.

In existing technologies, a flexible dimming device does not include an anti-ultraviolet film and a corresponding glass assembly does not have an anti-ultraviolet function. If an anti-ultraviolet function is added, an anti-ultraviolet film is needed to be pasted on the outside of the first glass 201 or the second glass substrate 503, and there is a need to add a process. In the glass assembly 200 provided by the present disclosure, the flexible dimming device 100 sandwiched between the first glass 201 and the second glass substrate 503 may include the anti-ultraviolet film 106, and may have the function of anti-ultraviolet. There may be no need to further paste the anti-ultraviolet film 106 on the outside of the first glass 201 or the second glass substrate 503, which simplifies the manufacturing process.

In another embodiment shown in FIG. 8 which is another schematic structure of the glass assembly, the glass assembly 200 may include the flexible dimming device 100 sandwiched between the first glass 201 and the second glass substrate 503. The flexible dimming device 100 in FIG. 8 may include the first flexible substrate 101 and the second flexible substrate 102 disposed opposite to each other, and the liquid crystal layer 103 sandwiched between the first flexible substrate 101 and the second flexible substrate 102. The liquid crystal layer 103 may include guest-host liquid crystal 1031 and dye molecules 1032. The flexible dimming device 100 may further include the first electrode 104 and the second electrode 105. The first electrode 104 may be located on the side of the first flexible substrate 101 away from the first adhesive film 107, and the second electrode 105 may be located on the side of the second flexible substrate 102 close to the liquid crystal layer 103. The anti-ultraviolet film 106 may be disposed on the side of the first flexible substrate 101 away from the second flexible substrate 102. The anti-ultraviolet film 106 and the first flexible substrate 101 may be bonded through the first adhesive film 107. The flexible dimming device 100 may further include a first anti-infrared film 1010 on the side of the second flexible substrate 102 away from the first flexible substrate 1010. The first anti-infrared film 1010 and the second flexible substrate 102 may be bonded through a second adhesive film 109. In this embodiment, the flexible dimming device 100 may be sandwiched between the first glass 201 and the second glass substrate 503. The first glass 201 and the anti-ultraviolet film 106 may be bonded through the fourth adhesive film 203. The second glass substrate 503 and the second flexible substrate 102 may be bonded together through the fifth adhesive film 204. The fourth adhesive film 203 and the fifth adhesive film 204 may be respectively used for bonding and fixing the flexible dimming device 100 and the first glass 201, and bonding and fixing the flexible dimming device 100 and the second glass substrate 503. The glass assembly 200 in the present embodiment may not only have a dimming function, but also have an anti-ultraviolet function and an anti-infrared function. Optionally, the fourth adhesive film 203 and the fifth adhesive film 204 may be made of a material including pressure sensitive adhesive, optical adhesive or liquid optical adhesive, which is not specifically limited here. In FIG. 8, pattern filling is not performed on the first glass 201 and the second glass substrate 503.

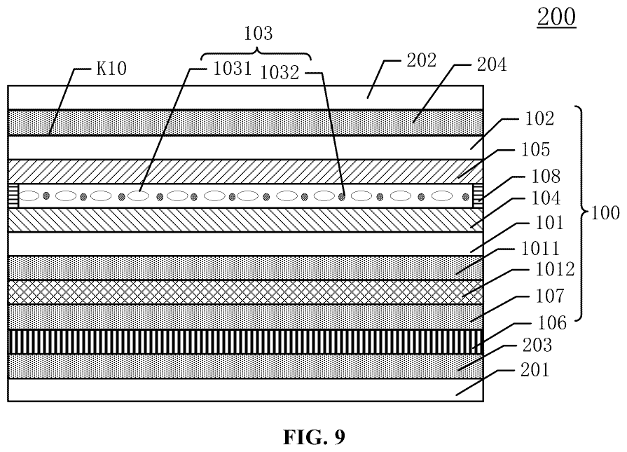

In another embodiment shown in FIG. 9 which is another schematic structure of the glass assembly, the glass assembly 200 may include the flexible dimming device 100 sandwiched between the first glass 201 and the second glass substrate 503. The flexible dimming device 100 in FIG. 9 may include the first flexible substrate 101 and the second flexible substrate 102 disposed opposite to each other, and the liquid crystal layer 103 sandwiched between the first flexible substrate 101 and the second flexible substrate 102. The liquid crystal layer 103 may include guest-host liquid crystal 1031 and dye molecules 1032. The flexible dimming device 100 may further include the first electrode 104 and the second electrode 105. The first electrode 104 may be located on the side of the first flexible substrate 101 away from the first adhesive film 107, and the second electrode 105 may be located on the side of the second flexible substrate 102 close to the liquid crystal layer 103. The anti-ultraviolet film 106 may be disposed on the side of the first flexible substrate 101 away from the second flexible substrate 102. The anti-ultraviolet film 106 and the first flexible substrate 101 may be bonded through the first adhesive film 107. The flexible dimming device 100 may further include a second anti-infrared film 1012 on the side of the first adhesive film 107 away from the anti-ultraviolet film 106. The second anti-infrared film 1012 and the first flexible substrate 101 may be bonded through a third adhesive film 1011. In this embodiment, the flexible dimming device 100 may be sandwiched between the first glass 201 and the second glass substrate 503. The first glass 201 and the anti-ultraviolet film 106 may be bonded through the fourth adhesive film 203. The second glass substrate 503 and the second flexible substrate 102 may be bonded together through the fifth adhesive film 204. The fourth adhesive film 203 and the fifth adhesive film 204 may be respectively used for bonding and fixing the flexible dimming device 100 and the first glass 201, and bonding and fixing the flexible dimming device 100 and the second glass substrate 503. The glass assembly 200 in the present embodiment may not only have a dimming function, but also have an anti-ultraviolet function and an anti-infrared function. Optionally, the fourth adhesive film 203 and the fifth adhesive film 204 may be made of a material including pressure sensitive adhesive, optical adhesive or liquid optical adhesive, which is not specifically limited here. In FIG. 9, pattern filling is not performed on the first glass 201 and the second glass substrate 503. The fourth adhesive film 203 and the fifth adhesive film 204 may be made of one of pressure-sensitive adhesive, optical adhesive or liquid optical adhesive.

In some embodiments shown in FIG. 7 to FIG. 9, the fourth adhesive film 203 and the fifth adhesive film 204 may be made of one of pressure-sensitive adhesive, optical adhesive or liquid optical adhesive.

The fourth adhesive film 203 and the fifth adhesive film 204 may be respectively used for bonding and fixing the flexible dimming device 100 and the first glass 201, and bonding and fixing the flexible dimming device 100 and the second glass substrate 503. The viscosities of the fourth adhesive film 203 and the fifth adhesive film 204 may need to be large enough to ensure the firmness of the glass assembly 200. The fourth adhesive film 203 and the fifth adhesive film 204 may be made of one of pressure-sensitive adhesive, optical adhesive or liquid optical adhesive.

The pressure-sensitive adhesive has long-lasting high viscosity. It only needs to apply pressure to bond the upper and lower layers of adherents. It does not need to be activated by water, solvents or heat. Because of its strong cohesive force, it may be able to play the role of bonding and fixing the flexible dimming device 100 and the first glass 201, and bonding and fixing the flexible dimming device 100 and the second glass substrate 503.

The optical adhesive (OCA) is a special adhesive used for bonding transparent optical components. Since optical adhesive has the characteristics of being colorless, transparent with a light transmittance above 90%, and good bonding strength, when bonding and fixing the flexible dimming device 100 with the first glass 201 and bonding and fixing the flexible dimming device 100 with the second glass substrate 503 through the optical adhesive, the optical adhesive may not only play a relatively good bonding effect, but also ensure the light transmittance of the glass assembly.

The liquid optical adhesive (LOCA) is a special adhesive used for bonding transparent optical components. Since it has the characteristics of colorless transparency with a light transmittance above 98%, and good bonding strength, when bonding and fixing the flexible dimming device 100 with the first glass 201 and bonding and fixing the flexible dimming device 100 with the second glass substrate 503 through the optical adhesive, the optical adhesive may not only play a relatively good bonding effect, but also ensure the light transmittance of the glass assembly. Further, the liquid optical adhesive also has the characteristics of a small curing shrinkage rate. After curing, there may be no change on the surface of the anti-ultraviolet film 106 and the first flexible substrate 101. Moreover, the liquid optical adhesive can resist yellowing. Even after the glass assembly is exposed to ambient light for a long time, the liquid optical adhesive may be still able to play the role of resisting yellowing.

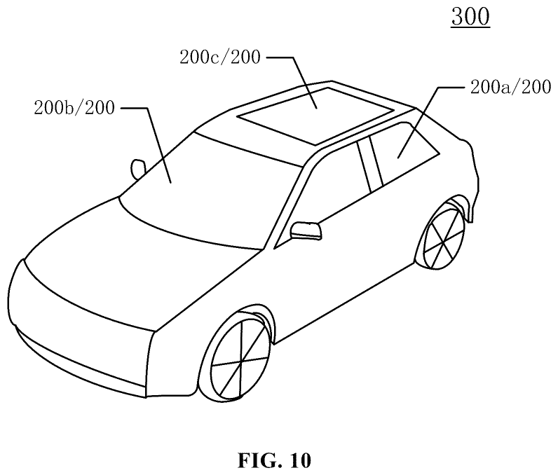

The present disclosure also provides an automobile 300. The automobile 300 may include a glass assembly 200 provided by any embodiment of the present disclosure. As shown in FIG. 10, in one embodiment, the automobile 300 may include a window glass 200a, a front windshield glass 200b and a rear windshield glass (not shown in the figure). In some other embodiments, the automobile 300 may further include a sunroof glass 200c. The glass assembly 200 provided by the present disclosure may be used as at least one of the window glass 200a, the front windshield glass 200b, the rear windshield glass 200c or the sunroof glass.

As shown in FIG. 7 to FIG. 9, the glass assembly 200 in FIG. 7 may have a dimming function (a function of switching between the transparent state and the light-shielding state) and an ultraviolet protection function. Therefore, after the glass assembly 200 is applied to the automobile 300, the window glass 200a, the front windshield glass 200b, the rear windshield glass (not shown in the figure), and the sunroof glass 200c may also have the dimming function and ultraviolet protection function accordingly. The glass assembly 200 in FIG. 8 and FIG. 9 may have the dimming function (the function of switching between the transparent state and the light-shielding state), the anti-ultraviolet function and the anti-infrared function at the same time. Therefore, after the glass assembly 200 is applied to the automobile 300, the window glass 200a, the front windshield glass 200b, the rear windshield glass (not shown in the figure), and the sunroof glass 200c may also have the dimming function, the anti-ultraviolet function and the anti-infrared function correspondingly.

In some optional embodiments, as shown in FIG. 10 in conjunction with FIGS. 7 to 9, the first glass 201 and the second glass substrate 503 may be made of tempered glass or plexiglass.

Optionally, the first glass 201 and the second glass substrate 503 may be made of the same glass or different glass. For example, both the first glass 201 and the second glass substrate 503 may be made of tempered glass. In another embodiment, the first glass 201 may be made of tempered glass, and the second glass substrate 503 may be made of plexiglass. In another embodiment, the first glass 201 may be made of plexiglass, and the second glass substrate 503 may be made of tempered glass. In another embodiment, both the first glass 201 and the second glass substrate 503 may be made of plexiglass. The present disclosure has no specific limit on this.

Tempered glass has higher hardness and can prevent scratches. For tempered glass, chemical or physical methods may be used to form compressive stress on the surface. When the glass is subjected to an external force, the surface stress may be first offset, thereby improving the bearing capacity of the first glass 201 and/or the second glass substrate 503, and enhancing the wind pressure resistance and impact resistance of the glass assembly 200 itself.

Plexiglass (polymethyl methacrylate) is a polymer compound polymerized by methacrylate, with smooth surface, bright colors, small specific gravity, high strength, corrosion resistance, moisture resistance, light resistance, good insulation performance, sound insulation. When the first glass 201 and/or the second glass substrate 503 are made of plexiglass and used as glass in the automobile 300, strength, corrosion resistance, light resistance and noise reduction of the glass assembly 200 may be improved.

In some optional embodiments, as shown in FIG. 10, the first glass 201 and the second glass substrate 503 may be made of tempered glass, and the glass assembly 200 may be used as the front windshield glass 200b.

In some other embodiments, the first glass 201 and the second glass substrate 503 may be made of plexiglass, and the glass assembly 200 may be used as the sunroof glass 200c.

It can be understood that, when the automobile 300 is running, the front windshield glass 200b may need to bear a large impact force. When the first glass 201 and the second glass substrate 503 are used as tempered glass, the wind pressure resistance and impact resistance of the glass assembly 200 may be ensured. Of course, because of the high hardness of the tempered glass, scratches on the front windshield glass 200b may be prevented.

The sunroof glass 200c may be arranged on the top of the automobile 300, and it may need to have heat insulation, sound insulation and light resistance. The plexiglass has its advantages in these respects. By forming the first glass 201 and the second glass substrate 503 from the plexiglass, the heat insulation, sound insulation and light resistance of the glass assembly 200 may be ensured. Also, the light weight of the plexiglass may be more suitable for the sunroof glass 200c.

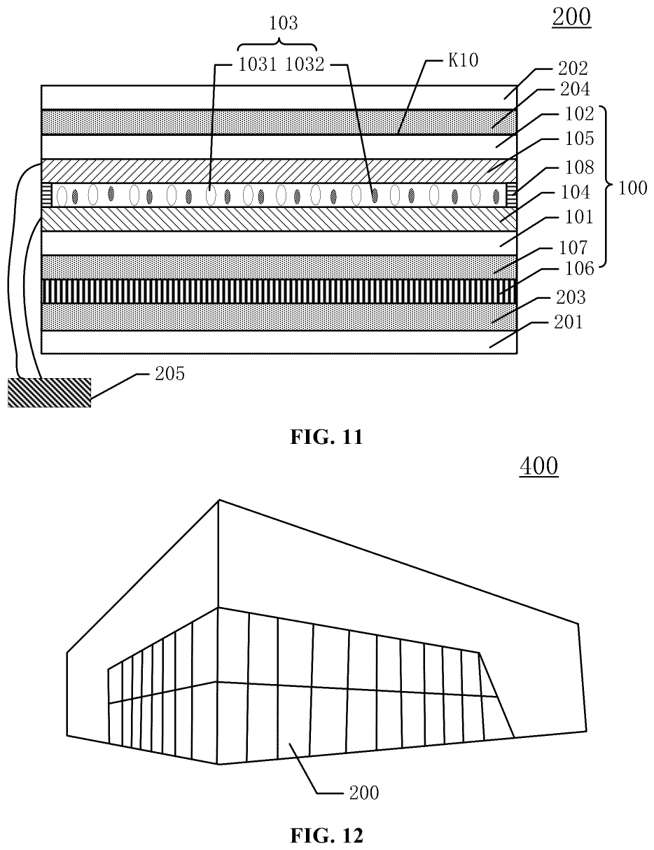

In some optional embodiments, as shown in FIG. 11 which is a schematic structural diagram of another glass assembly provided by the present disclosure and FIG. 10, the automobile 300 may further include a driver chip 205 (not shown in FIG. 10, as shown in FIG. 11), the driving chip 205 may be electrically connected to the first electrode 104 and the second electrode 105.

Optionally, the driver chip 205 may be disposed in a central control room of the automobile 300, and the position of the driver chip 205 is not specifically limited here. It is only a schematic illustration in FIG. 11, and only electrical connection relationship between the driver chip 205 and the first electrode 104 and the second electrode 105 is shown in FIG. 104.

It can be understood that the driving chip 205 may send the first signal and the second signal to the first electrode 104 and the second electrode 105 respectively, and the voltage difference between the first signal and the second signal may form an electric field for driving the deflection of the guest-host liquid crystal 1031, therefore, the flexible dimming device 100 is switched between a transparent state and a light-shielding state.

The present disclosure also provides a glass curtain wall 400 including a glass assembly 200 provided by any embodiment of the present disclosure. As shown in FIG. 12, which is a schematic structural diagram of the glass curtain wall, the glass curtain wall 400 may include a glass assembly 200 provided by any embodiment of the present disclosure, as shown in FIG. 7 to FIG. 9. The glass assembly 200 in FIG. 7 may have the dimming function (the function of switching between the transparent state and the light-shielding state) and the anti-ultraviolet function, therefore the glass curtain wall 400 including the glass assembly 200 may also have the dimming function and the anti-ultraviolet function correspondingly. The glass assembly 200 in FIG. 8 and FIG. 9 may have the dimming function (the function of switching between the transparent state and the light-shielding state), the anti-ultraviolet function and the anti-infrared function at the same time. Therefore, the glass curtain wall 400 including the glass assembly 200 may also have the dimming function, the anti-ultraviolet function and the anti-infrared function.

In some optional embodiments shown in FIG. 12 and FIG. 7 to FIG. 9, the first glass 201 and the second glass substrate 503 may include tempered glass.

The glass curtain wall 400 may be used as a building exterior wall, and it may need to have sufficient strength when exposed to the environment for a long time. The first glass 201 and the second glass substrate 503 may be made of tempered glass. For the tempered glass, chemical or physical methods may be used to form compressive stress on the surfaces. When the glass is subjected to an external force, the surface stress may be firstly offset, thereby improving the bearing capacity of the first glass 201 and/or the second glass substrate 503. The wind pressure resistance and impact resistance of the glass assembly 200 itself may be guaranteed, to ensure the performance stability of the glass curtain wall 400.

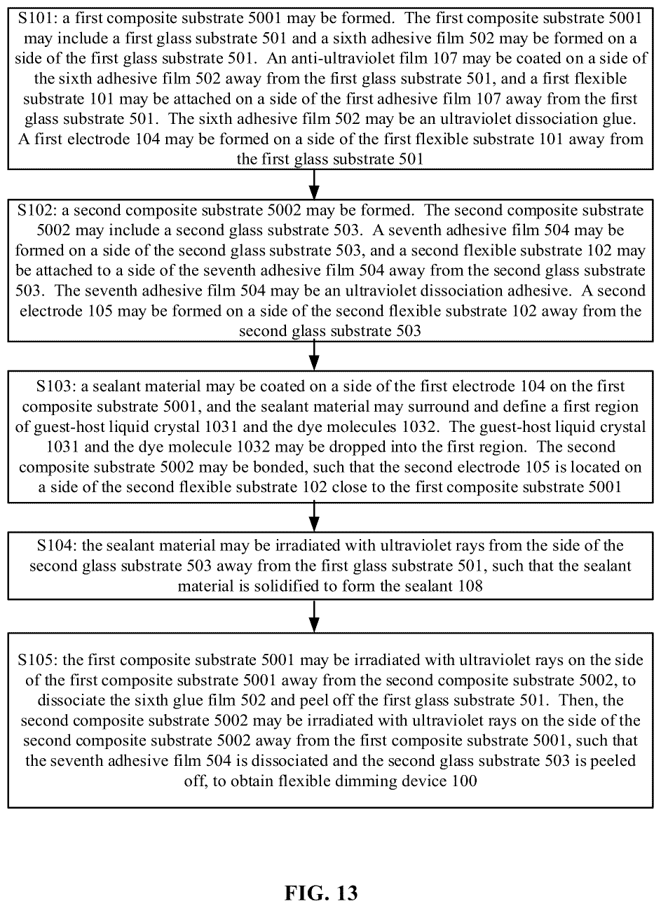

The present disclosure also provides a fabrication method of a flexible dimming device. As shown in FIG. 13, in one embodiment, the fabrication method may include S101 to S105.

In S101, a first composite substrate 5001 may be formed. The first composite substrate 5001 may include a first glass substrate 501 and a sixth adhesive film 502 may be formed on a side of the first glass substrate 501. An anti-ultraviolet film 107 may be coated on a side of the sixth adhesive film 502 away from the first glass substrate 501, and a first flexible substrate 101 may be attached on a side of the first adhesive film 107 away from the first glass substrate 501. The sixth adhesive film 502 may be an ultraviolet dissociation adhesive. A first electrode 104 may be formed on a side of the first flexible substrate 101 away from the first glass substrate 501.

In S102, a second composite substrate 5002 may be formed. The second composite substrate 5002 may include a second glass substrate 503. A seventh adhesive film 504 may be formed on a side of the second glass substrate 503, and a second flexible substrate 102 may be attached to a side of the seventh adhesive film 504 away from the second glass substrate 503. The seventh adhesive film 504 may be an ultraviolet dissociation adhesive. A second electrode 105 may be formed on a side of the second flexible substrate 102 away from the second glass substrate 503.

In S103, a sealant material may be coated on a side of the first electrode 104 on the first composite substrate 5001, and the sealant material may surround and define a first region of guest-host liquid crystal 1031 and the dye molecules 1032. The guest-host liquid crystal 1031 and the dye molecule 1032 may be dropped into the first region. The second composite substrate 5002 may be bonded, such that the second electrode 105 is located on a side of the second flexible substrate 102 close to the first composite substrate 5001. In another embodiment, in the first composite substrate 5001, one side of the first electrode 104 may be coated with a sealant material, and the sealant material may surround and define the first interval of the guest-host liquid crystal 1031 and the dye molecule 1032. A channel for the guest-host liquid crystal 1031 and the dye molecule 1032 may be reserved on the sealant material. The first composite substrate 5001 and the second composite substrate 5002 may be bonded with each other, and the guest-host liquid crystal 1031 and dye molecules 1032 may be injected through the channel.

In S104, the sealant material may be irradiated with ultraviolet rays from the side of the second glass substrate 503 away from the first glass substrate 501, such that the sealant material is solidified to form the sealant 108.

In S105, the first composite substrate 5001 may be irradiated with ultraviolet rays on the side of the first composite substrate 5001 away from the second composite substrate 5002, to dissociate the sixth adhesive film 502 and peel off the first glass substrate 501. Then, the second composite substrate 5002 may be irradiated with ultraviolet rays on the side of the second composite substrate 5002 away from the first composite substrate 5001, such that the seventh adhesive film 504 is dissociated and the second glass substrate 503 is peeled off, to obtain flexible dimming device 100. In another embodiment, the second composite substrate 5002 may be irradiated with ultraviolet rays on the side of the second composite substrate 5002 far away from the first composite substrate 5001 to dissociate the seventh adhesive film 504 and peel off the second glass substrate 503. Then, the first composite substrate 5001 may be irradiated with ultraviolet rays on the side of the first composite substrate 5001 away from the second composite substrate 5002 is irradiated with ultraviolet rays to the first composite substrate 5001, to dissociate the sixth adhesive film 502 and peel off the first glass substrate 501.

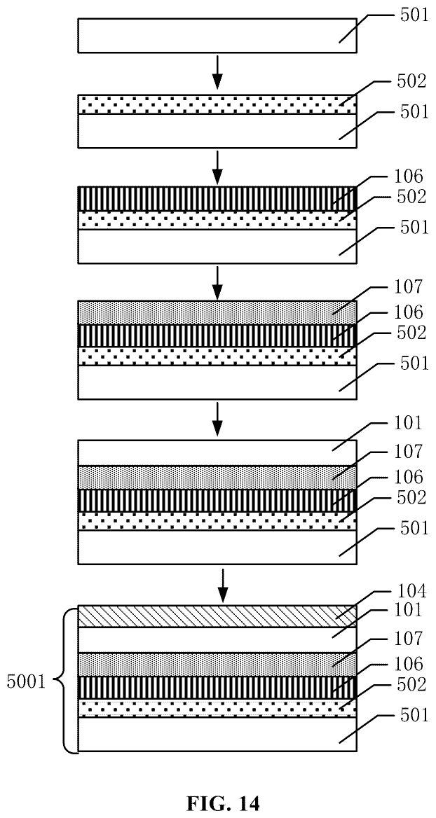

In S101, as shown in FIG. 14 which shows structures corresponding to various steps of a method for forming the first composite substrate and where the pattern filling is not performed on the first glass substrate 501, the first glass substrate 501 may be provided first. The first glass substrate 501 may be peeled off later, and the material of the first glass substrate 501 is not specifically limited as long as it has a certain rigidity to support the first flexible substrate 101.

The sixth adhesive film 502 may be formed on the first glass substrate 501. Since the first glass substrate 501 needs to be peeled off in the subsequent process, the sixth adhesive film 502 here may be made of ultraviolet dissolving adhesive. The ultraviolet dissolving adhesive may lose viscosity because of polymerization dissociation after ultraviolet irradiation. That is, after the sixth adhesive film 502 is irradiated with ultraviolet rays, the sixth adhesive film 502 may lose its viscosity, and the first glass substrate 501 may be detached from the first flexible substrate 101.

Then, the anti-ultraviolet film 106 may be coated on the side of the sixth adhesive film 502 away from the first glass substrate 501, and the first adhesive film 107 may be formed on the side of the anti-ultraviolet film 106 far away from the first glass substrate 501. The first flexible substrate 101 may be attached to the side of the first adhesive film 107 away from the first glass substrate 501, and the first electrode 104 may be formed on the side of the first flexible substrate 101 away from the first glass substrate 501. For the anti-ultraviolet film 106, the first adhesive film 107, the first flexible substrate 101 and the first electrode 104, the reference may be made to any one of the embodiments shown in FIG. 1 to FIG. 6, which will not be repeated here.

It should be noted that for S101, the anti-ultraviolet film 106 and the sixth adhesive film 502 may be pre-combined together by film material manufacturer as an integral film layer and used directly. Correspondingly, there may be no need to coating the anti-ultraviolet film 106 on the side of the six adhesive film 502 away from the first glass substrate 501, and it may only need to attach the composite film layer of the anti-ultraviolet film 106 and the sixth adhesive film 502 on the first glass substrate 501.

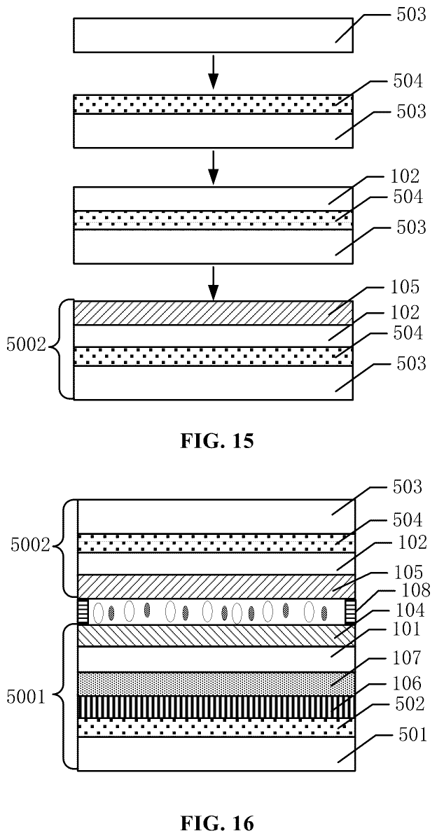

In S102, as shown in FIG. 15 which shows structures corresponding to various steps of a method for forming the first composite substrate and where the pattern filling is not performed on the second glass substrate 503, the seventh adhesive film 504 may be formed on the side of the second glass substrate 503, and then the second flexible substrate 102 may be bonded on the side of the seventh adhesive film 504 away from the second glass substrate 503. The second electrode 105 may be formed on the side of the second flexible substrate 102 away from the second glass substrate 503. Structural features of the second flexible substrate 102 and the second electrode 105 will not be repeated here. In this embodiment, the seventh adhesive film 504 may be an ultraviolet dissociation adhesive. It should be noted that since the second glass substrate 503 needs to be peeled off in the subsequent process, the seventh adhesive film 504 here may be made of ultraviolet dissociation adhesive. The ultraviolet dissolving adhesive may lose viscosity because of polymerization dissociation after ultraviolet irradiation. That is, after the seventh adhesive film 504 is irradiated with ultraviolet rays, the seventh adhesive film 504 may lose its viscosity, and the second glass substrate 503 may be detached from the second flexible substrate 102.

It should be noted that for S102, the seventh adhesive film 504 and the second flexible substrate 102 may be pre-combined together by film material manufacturer as an integral film layer and used directly. Correspondingly, there may be no need to form the seventh adhesive film 504 on one side of the second glass substrate 503, and it may only need to attach the composite film layer of the seventh adhesive film 504 and the second flexible substrate 102 on the second glass substrate 503.

S103 may be a cell forming process. There may be two methods for the cell forming process.

One method may be a dripping method. A sealant material may be coated on the side of the first electrode 104 on the first composite substrate 5001 formed in S101, and the sealant material may surround and define the first region of the guest-host liquid crystal 1031 and the dye molecules 1032. The guest-host liquid crystal 1031 and the dye molecule 1032 may be dropped into the first region. The second composite substrate 5002 formed in S102 may be bonded with the first composite substrate 5001, such that the second electrode 105 is located on the side of the second flexible substrate 102 close to the first composite substrate 5001, to form a liquid crystal cell, as shown in FIG. 16.

Another method may be an injection method. In the first composite substrate 5001 formed in S101, one side of the first electrode 104 may be coated with a sealant material, and the sealant material may surround and define the first interval of the guest-host liquid crystal 1031 and the dye molecule 1032. The channel for the guest-host liquid crystal 1031 and the dye molecule 1032 may be reserved on the sealant material. The first composite substrate 5001 and the second composite substrate 5002 may be bonded with each other, and the guest-host liquid crystal 1031 and dye molecules 1032 may be injected through the preserved channel, to form a liquid crystal cell, as shown in FIG. 16.

The above two methods both may be used to form the liquid crystal cell, and the present disclosure has no specific limit on this.

In S104, in the present disclosure, ultraviolet rays may be not used to irradiate the seal material on the side of the first glass substrate 501 close to the second glass substrate 503. The anti-ultraviolet film 106 may be disposed on the side of the first glass substrate 501 close to the second glass substrate 503, and may prevent ultraviolet rays from passing through the first flexible substrate and reaching the sealant material, reducing the curing effect of the sealant material. In S104, the sealant material may be irradiated with ultraviolet rays from the side of the second glass substrate 503 away from the first glass substrate 501, such that the sealant material is solidified to form the sealant 108. There may be no ultraviolet protection film 106 to block the passage of ultraviolet rays, which may not affect the curing effect of the sealant material.

It should be noted that, in the present disclosure, the production line or production process of liquid crystal cells in the existing technologies may be used to manufacture the flexible dimming device 100 with the anti-ultraviolet function, without adding other equipment.

In S105, the first glass substrate 501 may be peeled off first followed by peeling off the second glass substrate 503, or the second glass substrate 503 may be peeled off first followed by peeling off the first glass substrate 501.

In one embodiment, the first glass substrate 501 may be peeled off first followed by peeling off the second glass substrate 503. The first composite substrate 5001 may be irradiated with ultraviolet rays on the side of the first composite substrate 5001 away from the second composite substrate 5002, to dissociate the sixth adhesive film 502 and peel off the first glass substrate 501. Then, the second composite substrate 5002 may be irradiated with ultraviolet rays on the side of the second composite substrate 5002 away from the first composite substrate 5001, such that the seventh adhesive film 504 is dissociated and the second glass substrate 503 is peeled off, to obtain flexible dimming device 100 shown in FIG. 1 to FIG. 4.

The ultraviolet dissociative adhesive may preferentially polymerize on an interface on the side irradiated with ultraviolet rays, and thus remain on the interface. In the existing technologies, there is a problem that the ultraviolet dissolving adhesive remains on the first flexible substrate 101. In this embodiment, the sixth adhesive film 502 may be bonded to the first glass substrate 501 and the first flexible substrate. When ultraviolet rays are irradiated on the side of the first composite substrate 5001 away from the second composite substrate 5002, the sixth adhesive film 502 may have priority to polymerize on the interface of the first glass substrate 501, such that the sixth adhesive film 502 may first polymerize on the first glass substrate 501 and may not remain on the first flexible substrate. Therefore, the problem of residual adhesive on the surface may be alleviated. Similarly, the seventh adhesive film 504 may be bonded with the second glass substrate 503 and the second flexible substrate 102. When irradiating the second composite substrate 5002 with ultraviolet rays on the side of the second composite substrate 5002 away from the first composite substrate 5001, the seventh adhesive film 504 may be preferentially polymerized on the interface of the second glass substrate 503, such that the seventh adhesive film 504 may be first polymerized on the second glass substrate 503 may not remain on the second flexible substrate. Therefore, the problem of residual adhesive on the surface of the flexible substrate may be alleviated.

In another embodiment, the second glass substrate 503 may be peeled off first followed by peeling off the first glass substrate 501. The second composite substrate 5002 may be irradiated with ultraviolet rays on the side of the second composite substrate 5002 far away from the first composite substrate 5001 to dissociate the seventh adhesive film 504 and peel off the second glass substrate 503. Then, the first composite substrate 5001 may be irradiated with ultraviolet rays on the side of the first composite substrate 5001 away from the second composite substrate 5002 is irradiated with ultraviolet rays to the first composite substrate 5001, to dissociate the sixth adhesive film 502 and peel off the first glass substrate 501.

The ultraviolet dissociative adhesive may preferentially polymerize on an interface on the side irradiated with ultraviolet rays, and thus remain on the interface. In the existing technologies, there is a problem that the ultraviolet dissolving adhesive remains on the first flexible substrate 101. In this embodiment, the sixth adhesive film 502 may be bonded to the first glass substrate 501 and the first flexible substrate. When ultraviolet rays are irradiated on the side of the first composite substrate 5001 away from the second composite substrate 5002, the sixth adhesive film 502 may have priority to polymerize on the interface of the first glass substrate 501, such that the sixth adhesive film 502 may first polymerize on the first glass substrate 501 and may not remain on the first flexible substrate. Therefore, the problem of residual adhesive on the surface may be alleviated. Similarly, the seventh adhesive film 504 may be bonded with the second glass substrate 503 and the second flexible substrate 102. When irradiating the second composite substrate 5002 with ultraviolet rays on the side of the second composite substrate 5002 away from the first composite substrate 5001, the seventh adhesive film 504 may be preferentially polymerized on the interface of the second glass substrate 503, such that the seventh adhesive film 504 may be first polymerized on the second glass substrate 503 may not remain on the second flexible substrate. Therefore, the problem of residual adhesive on the surface of the flexible substrate may be alleviated.

In the fabrication method of the flexible dimming device provided by the present disclosure, the sealant material may be irradiated with the ultraviolet rays on the side of the second glass substrate 503 away from the first glass substrate 501, such that the sealant material is solidified to form the sealant 108. There may be no ultraviolet protection film 106 to block the passage of ultraviolet rays, which may not affect the curing effect of the sealant material.

Further, the first composite substrate 5001 may be irradiated with ultraviolet rays on the side of the first composite substrate 5001 away from the second composite substrate 5002, to dissociate the sixth adhesive film 502 and peel off the first glass substrate 501. Then, the second composite substrate 5002 may be irradiated with ultraviolet rays on the side of the second composite substrate 5002 away from the first composite substrate 5001, such that the seventh adhesive film 504 is dissociated and the second glass substrate 503 is peeled off, to obtain flexible dimming device 100. In another embodiment, the second composite substrate 5002 may be irradiated with ultraviolet rays on the side of the second composite substrate 5002 far away from the first composite substrate 5001 to dissociate the seventh adhesive film 504 and peel off the second glass substrate 503. Then, the first composite substrate 5001 may be irradiated with ultraviolet rays on the side of the first composite substrate 5001 away from the second composite substrate 5002 is irradiated with ultraviolet rays to the first composite substrate 5001, to dissociate the sixth adhesive film 502 and peel off the first glass substrate 501. When ultraviolet rays are irradiated on the side of the first composite substrate 5001 away from the second composite substrate 5002, the sixth adhesive film 502 may have priority to polymerize on the interface of the first glass substrate 501, such that the sixth adhesive film 502 may first polymerize on the first glass substrate 501 and may not remain on the first flexible substrate. Therefore, the problem of residual adhesive on the surface may be alleviated. Similarly, the seventh adhesive film 504 may be bonded with the second glass substrate 503 and the second flexible substrate 102. When irradiating the second composite substrate 5002 with ultraviolet rays on the side of the second composite substrate 5002 away from the first composite substrate 5001, the seventh adhesive film 504 may be preferentially polymerized on the interface of the second glass substrate 503, such that the seventh adhesive film 504 may be first polymerized on the second glass substrate 503 may not remain on the second flexible substrate. Therefore, the problem of residual adhesive on the surface of the flexible substrate may be alleviated.

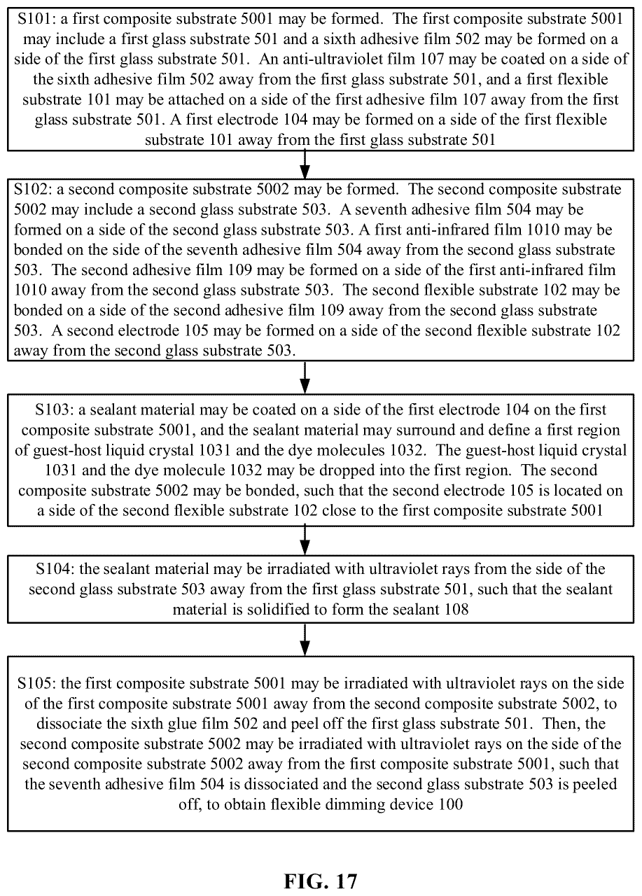

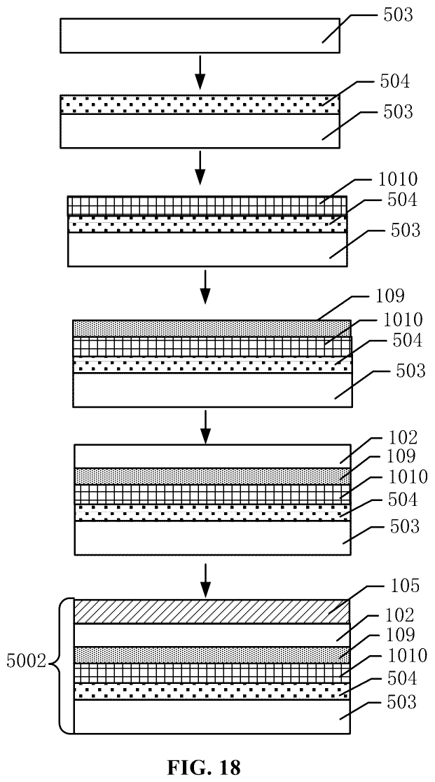

In some other embodiments shown in FIG. 17 and FIG. 18, in S102 for forming the second composite substrate 5002, after forming the seventh adhesive film 504 on the side of the second glass substrate 503 and before attaching the second flexible substrate 102 on the side of the seventh adhesive film 504 away from the second glass substrate 503, the method may further include:
attach a first anti-infrared film 1010 on the side of the seventh adhesive film 504 away from the second glass substrate 503;
forming the second adhesive film 109 on a side of the first anti-infrared film 1010 away from the second glass substrate 503; and
bonding the second flexible substrate 102 on a side of the second adhesive film 109 away from the second glass substrate 503.

Specifically, in the present embodiment, the second composite substrate 5002 may be formed by: providing the second glass substrate 503; forming the seventh adhesive film 504 on the second glass substrate 503; bonding first anti-infrared film 1010 on the side of the seventh adhesive film 504 away from the second glass substrate 503; forming the second adhesive film 109 on the side of the first anti-infrared film 1010 away from the second glass substrate 503; and bonding the second flexible substrate 102 on the side of the second adhesive film 109 away from the second glass substrate 503. The first anti-infrared film 1010 may be able to block infrared rays, such that the flexible dimming device 100 may have a heat-resistant function. The second adhesive film 109 may be made of one of pressure-sensitive adhesive, optical adhesive or liquid optical adhesive. The second adhesive film 109 may play a role of bonding the second adhesive film 109 and the second flexible substrate 102. In the second composite substrate 5002 prepared in this embodiment, the first anti-infrared film 1010 may be added, and the second composite substrate 5002 may be bonded with the first composite substrate 5001 to obtain the liquid crystal cell. Then the first glass substrate 501 and the second glass substrate 503 may be peeled off. The finally obtained flexible dimming device 100 may have an infrared-proof function, that is, have a heat-resistant function.

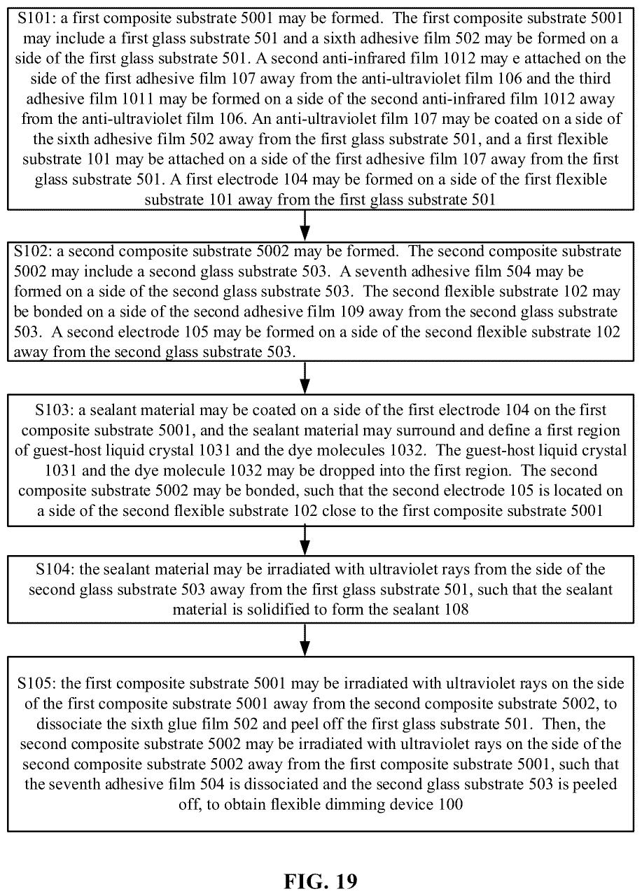

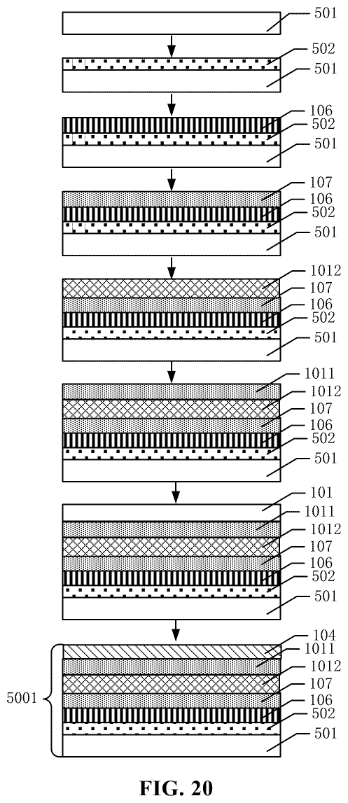

In some other embodiments shown in FIG. 19 and FIG. 20, in S101 for forming the first composite substrate 5001, after forming the first adhesive film 107 on the side of the anti-ultraviolet film 106 away from the first glass substrate and before attaching the first flexible substrate 101 on the side of the first adhesive film 107 away from the first glass substrate 501, the method may further include:
attach a second anti-infrared film 1012 on the side of the first adhesive film 107 away from the anti-ultraviolet film 106;
forming the third adhesive film 1011 on a side of the second anti-infrared film 1012 away from the anti-ultraviolet film 106; and
bonding the first flexible substrate 101 on a side of the third adhesive film 1011 away from the anti-ultraviolet film 106.

Specifically, in the present embodiment, the first composite substrate 5001 may be formed by: providing the first glass substrate 501; forming the sixth adhesive film 502 on the side of the first glass substrate 501; coating the side of the sixth adhesive film 502 away from the first glass substrate 501 with the anti-ultraviolet film 106; forming the first adhesive film 107 on the side of the anti-ultraviolet film 106 away from the first glass substrate 501; attaching the second anti-infrared film 1012 on the side of the first adhesive film 107 away from the anti-ultraviolet film 106; forming the third adhesive film 1011 on the side of the second anti-infrared film 1012 away from the anti-ultraviolet film 106; and bonding the first flexible substrate 101 on the side of the third adhesive film 1011 away from the anti-ultraviolet film 106. The sixth adhesive film 502 may be an ultraviolet dissociation adhesive, such that the first glass substrate 501 may be able to be peeled off later. The first adhesive film 107 may play the role of bonding the anti-ultraviolet film 106 and the second anti-infrared film 1012, and the third adhesive film 1011 may play the role of bonding the second anti-infrared film 1012 and the first flexible substrate 101. In the first composite substrate 5001 prepared in this embodiment, the second anti-infrared film 1012 may be added, and the second composite substrate 5002 and the first composite substrate 5001 may be bonded to obtain the liquid crystal cell. Then the first glass substrate 501 and the second glass substrate 503 may be peeled off. The finally obtained flexible dimming device 100 may have an infrared-proof function, that is, have a heat-resistant function.

The first adhesive film 107 and the second anti-infrared film 1012 may be pre-combined together by film material manufacturers and used directly as an integral film layer. Correspondingly, there may be no need to attach the second anti-infrared film 1012 on the side of the first adhesive film 107 away from the anti-ultraviolet film 106, and a composite film layer of the first adhesive film 107 and the second anti-infrared film 1012 may be bonded on the side of the anti-ultraviolet film 106 away from the first glass substrate 501.

Similarly, the third adhesive film 1011 and the first flexible substrate 101 may be pre-combined together by film material manufacturers and used directly as an integral film layer. Correspondingly, it may be unnecessary to attach the first flexible substrate 101 on the side of the third adhesive film 1011 away from the anti-ultraviolet film 106. A composite film layer of the third adhesive film 1011 and the first flexible substrate 101 may be bonded on the side of the second anti-infrared film 1012 away from the anti-ultraviolet film 106.

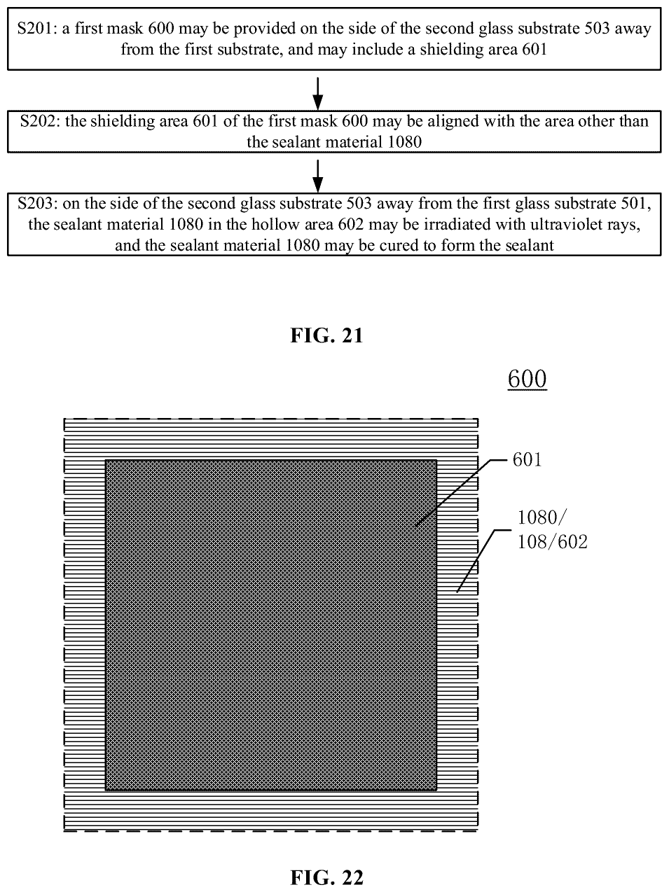

In some embodiments shown in FIG. 21 which shows a method for forming the sealant and FIG. 22 which shows a planar structure of a mask, irradiating the sealant material on the side of the second glass substrate 503 away from the first glass substrate 501 with ultraviolet rays such that the sealant material is cured to form the sealant 108 may include S201 to S203.

In S201, a first mask 600 may be provided. The first mask 600 may be disposed on the side of the second glass substrate 503 away from the first substrate, and may include a shielding area 601.

In S202, the shielding area 601 of the first mask 600 may be aligned with the area other than the sealant material 1080.

In S203, on the side of the second glass substrate 503 away from the first glass substrate 501, the sealant material 1080 in the hollow area 602 may be irradiated with ultraviolet rays, and the sealant material 1080 may be cured to form the sealant.

FIG. 22 shows the position of the sealant material of the first mask 600 in use.

In this embodiment, when curing the sealant material, it may be necessary to block the area other than the sealant material that needs to be cured. The first area surrounded by the frame material may include liquid crystal molecules, and the light energy when curing the sealant material may be relatively high, usually up to 14000 mJ, This light energy may damage the liquid crystal molecules. Therefore, the first mask 600 may be used to shield the liquid crystal molecules to reduce the damage to the liquid crystal molecules.

It should be noted that there may be no need to set up masks and other equipment when curing and dissociating the sixth adhesive film 502 and the seventh adhesive film 504. The light energy of the ultraviolet rays when curing and dissociating the ultraviolet dissociation adhesive is usually small, generally 2000-3000 mJ, and may not cause damage to the liquid crystal molecules.

In the flexible dimming device and its fabrication method, the glass assembly, the automobile, and the glass curtain wall provided by the present disclosure, the flexible dimming device may include the first flexible substrate and the second flexible substrate oppositely arranged, and the liquid crystal layer sandwiched between the first flexible substrate and the second flexible substrate. The liquid crystal layer may include the guest-host liquid crystals and the dye molecules. The flexible dimming device may further include the first electrode and the second electrode. The first electrode may be located on the side of the first flexible substrate away from the first adhesive film, and the second electrode may be located on the side of the second flexible substrate close to the liquid crystal layer. One side of the second flexible substrate may be further provided with the anti-ultraviolet film, and the anti-ultraviolet film may be bonded to the first flexible substrate through the first adhesive film. The flexible dimming device may realize the dimming function, that is, the function of switching between the transparent and light-shielding states. Light may be able to pass through the flexible dimming device in the transparent state, and may be unable to pass through the flexible dimming device in the light-shielding state to realize the light-shielding effect. Since the first flexible base and the second flexible base may be made of flexible materials, the requirements of bending may be satisfied. The side of the first flexible substrate away from the second flexible substrate may be further provided with the anti-ultraviolet film which has the function of preventing ultraviolet rays from passing. The transmittance may be very low when the ultraviolet light is irradiated on the anti-ultraviolet film, such that the flexible dimming device has the function of anti-ultraviolet while having the function of dimming. In the present disclosure, the anti-ultraviolet film may be directly integrated into the flexible dimming device, and there may be no need to attach an anti-ultraviolet film layer on the outside of the glass, which reduces the production process and production cost.

The sealant material may be irradiated with ultraviolet rays from the side of the second glass substrate away from the first glass substrate, such that the sealant material is cured to form the sealant. There may be no ultraviolet protection film to block the passage of ultraviolet rays, which may not affect the curing effect of the sealant material. On the side of the first composite substrate away from the second composite substrate, the ultraviolet rays may be used to irradiate the first composite substrate to dissociate the sixth adhesive film and peel off the first glass substrate. Then, the second composite substrate may be irradiated with the ultraviolet rays on the side of the second composite substrate away from the first composite substrate, to dissociate the seventh adhesive film and peel off the second glass substrate, to obtain the flexible dimming device. Or, the second composite substrate may be irradiated with the ultraviolet rays on the side of the second composite substrate away from the first composite substrate, to dissociate the seventh adhesive film and peel of the second glass substrate. Then, the first composite substrate may be irradiated with the ultraviolet rays on the side of the first composite substrate away from the second composite substrate to dissociate the sixth adhesive film and peel off the first glass substrate. When ultraviolet rays are irradiated on the side of the first composite substrate away from the second composite substrate, the sixth adhesive film may have priority to polymerize on the interface of the first glass substrate, such that the sixth adhesive film may first polymerize on the first glass substrate and may not remain on the first flexible substrate. Therefore, the problem of residual adhesive on the surface may be alleviated. When irradiating the second composite substrate with ultraviolet rays on the side of the second composite substrate away from the first composite substrate, the seventh adhesive film may be preferentially polymerized on the interface of the second glass substrate, such that the seventh adhesive film may be first polymerized on the second glass substrate may not remain on the second flexible substrate. Therefore, the problem of residual adhesive on the surface of the flexible substrate may be alleviated.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the disclosure. Thus, while the present disclosure has been described in detail with reference to the above described embodiments, the present disclosure is not limited to the above described embodiments, but may be embodied in other equivalent forms without departing from the scope of the present disclosure, which is determined by the appended claims.

What is claimed is:

1. A flexible dimming device, comprising:
a first flexible substrate and a second flexible substrate opposite to each other;
a liquid crystal layer sandwiched between the first flexible substrate and the second flexible substrate, wherein the liquid crystal layer includes guest-host liquid crystals and dye molecules;
a first electrode and a second electrode, wherein the first electrode is located on a side of the first flexible substrate close to the liquid crystal layer and the second electrode is located on a side of the second flexible substrate close to the liquid crystal layer; and
an anti-ultraviolet film on a side of the first flexible substrate away from the second flexible substrate, wherein the anti-ultraviolet film and the first flexible substrate are bonded by a first adhesive film.

2. The device according to claim 1, wherein the first adhesive film is made of a material including one of pressure sensitive adhesive, optical adhesive, or liquid optical adhesive.

3. The device according to claim 1, wherein:
the anti-ultraviolet film includes an anti-ultraviolet coating layer.

4. The device according to claim 1, wherein:
the first flexible substrate and the second flexible substrate are made of a material including one or more of polyimide, polyethylene naphthalate, cellulose triacetate, or cycloolefin polymer.

5. The device according to claim 1, wherein:
the anti-ultraviolet film is made of a material including polyethylene naphthalate or an ultraviolet blocking agent.

6. The device according to claim 1, further comprising a first anti-infrared film on a side of the second flexible substrate away from the first flexible substrate, wherein:
the first anti-infrared film and the second flexible substrate are bonded through a second adhesive film.

7. The device according to claim 1, further comprising a second anti-infrared film on a side of the first adhesive film away from the anti-ultraviolet film, wherein:
the second anti-infrared film and the first flexible substrate are bonded through a third adhesive film.

8. A glass assembly, comprising:
the flexible dimming device according to claim 1,
a first glass on a side of the anti-ultraviolet film away from the first flexible substrate; and
a second glass on a side of the second flexible substrate away from the first flexible substrate,
wherein:
the first glass and the anti-ultraviolet film are bonded through a fourth adhesive film; and
the second glass and the anti-ultraviolet film are bonded through a fifth adhesive film.

9. The glass assembly according to claim 8, wherein:
the fourth adhesive film and the fifth adhesive film are made of a material including one of pressure sensitive adhesive, optical adhesive, or liquid optical adhesive.

10. An automobile comprising the glass assembly according to claim 8.

11. The automobile according to claim 10, wherein:
the first glass and the second glass are made of a material including tempered glass or plexiglass.

12. The automobile according to claim 10, wherein:
the first glass and the second glass are made of tempered glass, and the glass assembly is used as a front windshield glass; or
the first glass and the second glass are made of plexiglass, and the glass assembly is used as a sunroof glass.

13. The automobile according to claim 10, further comprising a driving chip electrically connected to the first electrode and the second electrode.

14. A glass curtain wall comprising the glass assembly according to claim 8.

15. The glass curtain wall according to claim 14, wherein:
the first glass and the second glass are made of a material including tempered glass.

16. A fabrication method of a flexible dimming device, comprising:
forming a first composite substrate, including: providing a first glass substrate, forming a sixth adhesive film on a side of the first glass substrate, coating an anti-ultraviolet film on a side of the sixth adhesive film away from the first glass substrate, forming a first adhesive film on a side of the anti-ultraviolet film away from the first glass substrate, bonding a first flexible substrate on a side of the first adhesive film away from the first glass substrate, and forming a first electrode on the side of the first flexible substrate away from the first glass substrate, wherein the sixth adhesive film includes ultraviolet dissociation adhesive;
forming a second composite substrate, including: providing a second glass substrate, forming a seventh adhesive film on a side of the second glass substrate, bonding a second flexible base on a side of the seventh adhesive film away from the second glass substrate, and forming a second electrode on the side of the second flexible substrate away from the second glass substrate, wherein the seventh adhesive film includes ultraviolet dissociation adhesive;
coating a side of the first electrode in the first composite substrate with a sealant material wherein the sealant material surrounds and defines a first region of guest-host liquid crystals and dye molecules, dripping the guest-host liquid crystal and the dye molecules into the first region, and bonding the second composite substrate such that the second electrode is located on a side of the second flexible substrate close to the first composite substrate; or, coating a side of the first electrode in the first composite substrate with a sealant material wherein the sealant material surrounds and defines a first region of guest-host liquid crystals and dye molecules and a channel for guest-host liquid crystals and dye molecules is preserved, bonding the first composite substrate and the second composite substrate, and injecting the guest-host liquid crystals and dye molecules through the channel;
irradiating the sealant material with ultraviolet rays on the side of the second glass substrate away from the first glass substrate to cure the sealant material to form a sealant;
irradiating the first composite substrate with ultraviolet rays on the side of the first composite substrate away from the second composite substrate, to dissociate the sixth adhesive film and peel off the first glass substrate, and then irradiating the second composite substrate with ultraviolet rays on the side of the second composite substrate away from the first composite substrate to dissociate the seventh adhesive film and peel off the second glass substrate to obtain the flexible dimming device; or, irradiating the second composite substrate with ultraviolet rays on the side of the second composite substrate away from the first composite substrate, to dissociate the seventh adhesive film and peel off the second glass substrate, and then irradiating the first composite substrate with ultraviolet rays on the side of the first composite substrate away from the second composite substrate to dissociate the sixth adhesive film and peel off the first glass substrate to obtain the flexible dimming device.

17. The method according to claim 16, wherein:
after forming the seventh adhesive film on the side of the second glass substrate and before attaching the second flexible substrate on the side of the seventh adhesive film far away from the second glass substrate, forming the second composite substrate further includes:
attaching a first anti-infrared film to the side of the seventh adhesive film away from the second glass substrate;
forming a second adhesive film on a side of the first anti-infrared film away from the second glass substrate; and
bonding the second flexible substrate to a side of the second adhesive film away from the second glass substrate.

18. The method according to claim 16, wherein:
after forming the first adhesive film on the side of the anti-ultraviolet film away from the first glass substrate and before attaching the first flexible substrate on the side of the first adhesive film far away from the first glass substrate, forming the first composite substrate further includes:
attaching a second anti-infrared film to the side of the first adhesive film far away from the anti-ultraviolet film;
forming a third adhesive film on a side of the second anti-infrared film away from the anti-ultraviolet film; and
bonding the first flexible substrate to a side of the third adhesive film away from the anti-ultraviolet film.

19. The method according to claim 16, wherein:
irradiating the sealant material with ultraviolet rays on the side of the second glass substrate away from the first glass substrate to cure the sealant material to form the sealant includes:
providing a first mask and placing the first mask on the side of the second glass substrate away from the first glass substrate, wherein the first mask plate includes a shielding area;
aligning the shielding area of the first mask plate with an area other than the sealant material; and
on the side of the second glass substrate away from the first glass substrate, irradiating the sealant material in a hollowed area with ultraviolet rays, such that the sealant material is cured to form the sealant.
